(19) United States
(12) Patent Application Publication
(10) Pub. No.: US 2003/0037430 A1
(43) Pub. Date: Feb. 27, 2003

(54) Apparatus for in-line extraction, activation and sealing of a storage battery

(76) Inventors: Bruce Everett Lasley, Fishers, IN (US); Morgan Rey Benson, Indianapolis, IN (US)

Correspondence Address: MARGARET A. DOBROWITSKY,, DELPHI TECHNOLOGIES, INC., 4TH FLOOR, 1450 W. LONG LAKE ROAD, TROY, MI, 48098, US

(21) Appl. No.: 09/940,116

(22) Filed: Aug. 27, 2001

(51) Int. Cl. H01M 10/04

(52) U.S. Cl. 29/623.1; 29/730; 29/623.2

(57) ABSTRACT

An apparatus is provided for performing in-line extraction, activation and sealing of a lithium polymer (LiPo) battery. The apparatus includes a pair of nosepieces that are inserted into opposing, open sides of the battery. A pair of clamp and seal arrangements associated with each nosepiece are moved from an insertion position to a clamp/seal position wherein outer packaging of the battery is sealed against an outer, convex surface of the nosepieces. Thereafter, an extraction fluid, such as heated, dry air or an inert atmosphere may be drawn through the battery, the nosepieces providing access to the interior of the battery, to thereby effect extraction. Thereafter, an electrolyte may be drawn into the interior of the battery using the nosepieces. A pair of sealing bars seal the open sides of the packaging.

### RELATED APPLICATIONS

This application claims the benefit of copending application entitled “BATTERY CONSTRUCTED WITH EXTRACTED BICELLS STACKED ON SHUTTLED PALLET,” attorney docket no. DP-306072, assigned to the common assignee of the present invention, filed on even date herewith, and herein incorporated by reference in its entirety.

### BACKGROUND OF THE INVENTION

1. Technical Field

The invention relates to storage batteries and more particularly to an improved apparatus and method for extracting, activating and sealing storage batteries.

2. Description of Related Art

A processing step for a type of storage battery known as a lithium polymer (LiPo) cell is referred to as an extraction step. The extraction step involves removal of a plasticizer to create micropores, which are subsequently backfilled with an electrolyte. The step of introducing electrolyte to activate the cell is known, not surprisingly, as activation.

A known process for extraction is a batch process wherein multiple lithium polymer cells are subjected to dry, heated air in a drying oven. To accomplish extraction thus requires moving cells in and out of the drying oven, which complicates the overall manufacturing process, as well as reduces throughput. Additionally, the drying oven itself presents an additional cost in the overall manufacturing process.

Electrolyte is generally sensitive to exposure to an uncontrolled atmosphere. Cell components are preferably not exposed to an uncontrolled atmosphere, since the electrolyte may absorb moisture during even short periods of exposure, with consequent degradation of the performance of the cell. In order to avoid exposure of the electrolyte to the atmosphere during the activation process, it is conventional practice to perform all work relating to the activation process in a controlled atmosphere. Specifically, inactivated LiPo cells are conventionally positioned in a glove box or other isolator containing an inert, dry atmosphere (e.g., less than 25 ppm moisture). The cells are then activated by the addition of the electrolyte. The cells are then hermetically sealed to prevent the intrusion of moisture and other contaminants. The sealed cells are thereafter removed from the glove box. After a period of time, usually within one week, the cells may again be positioned in the controlled atmosphere of the glove box to allow for a de-gas procedure (i.e., to allow the gas that has built up to escape), and are then resealed. Use of the glove box, however, has certain shortcomings.

Special purging procedures are required for the entry and exit of cells to and from the glove box. The special procedures are time consuming, which reduces throughput, as well as tedious. The glove box itself has a certain cost which increases the overall manufacturing cost. Additionally, it is necessary to constantly bring other materials into and out of the glove box while maintaining a carefully controlled atmosphere in the glove box. Thus, while the known approaches taken in the art are generally satisfactory with respect to achieving activation and sealing, they are not suited for use in a mass production environment, due to throughput limitations, special procedures, increased cost, and the taking of the cells out of an inline fabrication process.

U.S. Pat. No. 6,248,138 to LaFave et al. Disclose an apparatus for activation and sealing of a storage battery.

There is therefore a need for an improved system and method for accomplishing the functions of extraction, activation and sealing of a storage battery, such as a lithium polymer cell, that minimizes or eliminates one or more of the shortcomings set forth above.

### SUMMARY OF THE INVENTION

It is an object of the present invention to provide a solution to one or more of the above-mentioned problems. The present invention has the advantage of providing the above-described extraction function on a per piece basis without the complexity, and added expense of an extraction chamber (e.g., drying oven). In addition, the present invention has the advantage of providing the activation and sealing functions described above without the reduced throughput (i.e., time consuming entry and exit procedures), complexity and added expense associated with the use of a glove box. Moreover, the invention allows for a continuous in-line fabrication process of a storage battery, without the conventional disruption of having to run components thereof (e.g., bicells) through a drying oven, or without having to run the cell itself through a glove box for activation and final sealing.

In accordance with the present invention, an apparatus is provided that is configured to allow a fluid (described more fully below) to flow into a storage battery, such as a LiPo cell, all in an uncontrolled atmosphere. The apparatus is adapted for use with such a battery of the type having an interior, which may contain one or more bicells, surrounded by packaging having at least a first open side. The apparatus includes a nosepiece with an insertion end. The nosepiece includes at least one conduit therethrough having an opening on the insertion end for communicating with the interior of the battery. The apparatus further includes a clamp and seal arrangement configured to clamp and seal the packaging material against the nose when the insertion end is inserted in the open side. Once clamped and sealed, fluid communication can occur into the interior of the battery, in an uncontrolled atmosphere, and without the need for a separate chamber (e.g., drying oven and/or glove box).

In a preferred embodiment, the apparatus further includes a base for receiving the battery. The packaging is (i) sealed on a first pair of opposing sides, and (ii) open on a second pair of opposing sides. A second nosepiece and a second clamp and seal arrangement are provided for use on the other open side of the packaging, opposite the first open side described above. During an extraction phase, the first nosepiece is configured for connection to an extraction fluid source (e.g., dry, heated inert atmosphere) while the second nosepiece is configured for connection to a vacuum source for pulling the extraction fluid through the interior of the battery (i.e., inside of the packaging) thereby extracting predetermined constituents (e.g., plasticizers) from the bicells. During a second, activation phase, the first nosepiece is configured for connection to an electrolyte source for introducing electrolyte into the interior to thereby activate the battery. The apparatus further includes, in this preferred embodiment, first and second sealing devices configured to seal the opposing, open sides of the packaging during a sealing phase. The apparatus provides for in-line extraction, activation and sealing in an uncontrolled atmosphere without the need for a drying oven or a glove box.

A method of making a storage cell is also presented.

### BRIEF DESCRIPTION OF THE DRAWINGS

The present invention will now be described, by way of example, with reference to the accompanying drawings, in which:

FIG. 1 is a simplified, perspective view of a lithium polymer cell suitable for use with the system and method according to the present invention.

FIG. 2 is a simplified, plan view of a preferred embodiment of an extraction, activation and sealing apparatus according to the present invention.

FIG. 3 is a simplified, side view of a clamp and seal arrangement shown in FIG. 2.

FIG. 4 is a simplified, cross-sectional view taken substantially along lines 44 of FIG. 3, showing the clamp and seal arrangement in an engaged position.

### DETAILED DESCRIPTION OF THE PREFERRED EMBODIMENTS

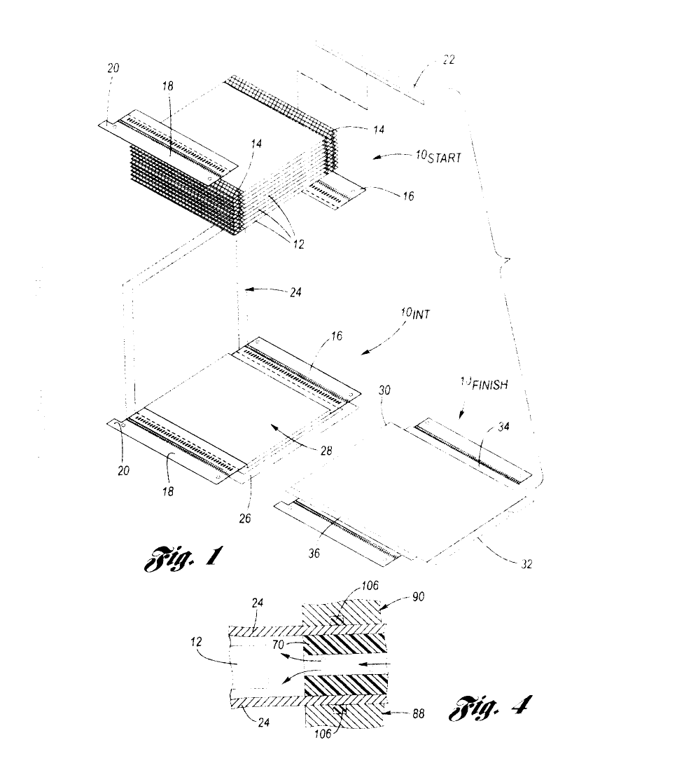

Referring now to the drawings wherein like reference numerals are used to identify identical components in the various views, FIG. 1 is a simplified, perspective view of a storage battery 10 which may be fabricated, in-part, using the method and apparatus of the present invention. The method and apparatus of the present invention provides a simplified, reduced cost, increased throughput, mechanism for in-line extraction, activation and sealing of battery 10, all in an uncontrolled atmosphere. Before proceeding to a detailed description of the inventive apparatus and method, a brief description of storage battery 10, and its component parts, will be set forth so that one of ordinary skill in the art can more fully appreciate the challenges presented, and the improvements provided by the present invention.

FIG. 1 shows battery 10 in three stages of completion, namely, a start stage of completion, designated 10_{START}, an intermediate stage of completion, designated 10_{INT}, and a “finished” stage of completion (i.e., finished as to the mechanical association of component parts), designated 10_{FINISH}. Battery 10_{START} includes one or more bicells, 12 each including positive and negative grids 14, a positive terminal or tab 16, and a negative terminal or tab 18, which may contain a tang 20. FIG. 1 further illustrates a cover strip 22 and packaging material 24.

Each of the bicells 12 may comprise a conventional bicell, as known in the art, for example, as seen by reference to U.S. Pat. No. 6,063,519 issued to Barker, et al entitled “GRID PLACEMENT IN LITHIUM ION BICELL COUNTER ELECTRODES”, hereby incorporated by reference in its entirety. Grids 14 may comprise expanded metal material, foil, mesh or the like, and are formed on opposing sides of the bicells. The grids 14 of each bicell are exposed and are current carriers, as known. Grids 14 may comprise, for example, aluminum material (i.e., for connection to positive terminal 16) and copper material (i.e., for connection to negative terminal 18). The cathodic grids associated with positive terminal 16 may be ultrasonically welded together. The anodic grids associated with negative terminal 18 may also be ultrasonically welded together. In the illustrated embodiment, the positive terminal 16 may be ultrasonically welded to an exposed surface of the cathodic grids, while the negative terminal 18 may be ultrasonically welded to an exposed surface of the anodic grids. The grids 14, however, are relative fragile and thus, to prevent damage during the ultrasonic welding operation, a cover strip is placed on an opposing side relative to the side where the terminal is to be attached. For example, as shown in FIG. 1, positive terminal 16 is shown on the bottom, with a corresponding cover strip 22 being provided on top. Likewise, a cover strip 22 is also placed on the bottom (not shown to maintain clarity in the Figure), on the side of the stack of bicells opposite of where negative terminal 18 is located. The cover strip 22 is preferably made from the same material as the terminal with which it is paired (copper with copper, aluminum with aluminun). The cover strip provides an ultrasonic welding horn an opposing, reaction surface to grip. In the context of the present invention, the bicells 12 have not yet undergone the extraction step to remove plasticizer to form pores suitable for backfill with electrolyte.

With continued reference to FIG. 1, in the intermediate phase of construction (10 _{INT}), packaging material 24 is used to enclose and surround bicells 12, terminals 16 and 18, and cover strips 22. Packaging 24 may comprise a unitary sheet, which is folded to enclose bicells 12. Packaging 24 may be a type of laminated, aluminized flexible material having, among other things, an outer layer comprising electrical insulating material (e.g., polyester), an intermediate layer containing metal (e.g., aluminum) for reducing moisture transit (i.e., provides a bidirectional moisture barrier), and an inner layer of electrical insulating material (e.g., polyester). The packaging 24 may also include an adhesive 26, which may comprise a conventional sealing hot melt adhesive, for example, ethylene acrylic acid (EAA). An interior 28 of battery 10, defined as being the inside of the packaging 24, contains at least one, and preferably a plurality of bicells 12.

As further shown in FIG. 1, storage battery 10_{FINISH} is characterized by packaging 24 completely surrounding bicells 12. Battery 10_{FINISH} includes a first pair of opposing sides 30, 32 (i.e., the non-tab sides), and a second pair of opposing sides 34, 36 (i.e., the tab sides). Conventionally, the tab pair of opposing sides 34, 36 are sealed, for example, through use of a sealing bar (i.e., that applies heat). Side 30 may be sealed already by virtue of being a fold or hinge, while side 32 remains open. It should be appreciated, however, that further steps are needed to produce a fully functioning storage battery 10, namely, an extraction step, an activation step (i.e., introducing electrolyte into interior 28), and a final sealing step, among other things. For example, such other steps, may include formation (i.e., charging).

The apparatus and method according to the present invention facilitates performance of the extraction, activation, and sealing steps referred to above. The present invention provides the mechanism to perform such steps in an in-line fashion with other manufacturing steps, in an uncontrolled atmosphere. That is, the invention eliminates the need to use a separate drying oven for the extraction step, and a glove box for the activation and final sealing steps, thus eliminating the disadvantages of both described in the Background.

FIG. 2 is a simplified, plan view of an apparatus 40 for in-line extraction, activation and sealing of a storage battery 10, such as a LiPo battery 10 as illustrated in FIG. 1. With the foregoing background information concerning battery 10 in mind, FIG. 2 shows the apparatus 40 including a base 42, a first nosepiece 44, a second nosepiece 46, a first clamp and seal arrangement 48, a second clamp and seal arrangement 50, a first seal device, such as a sealing bar 52, a second seal device, such as a sealing bar 54, a first vacuum source 56, a valve assembly 58, a controller 60, a heated/dry air source 62, an inert atmosphere source 64, an electrolyte source 66, and a second vacuum source 68.

Base 42 is configured for receiving a storage battery 10 of the type described above in connection with FIG. 1. Base 42, as shown, is generally planar, and may comprise conventional materials having electrical insulating characteristics.

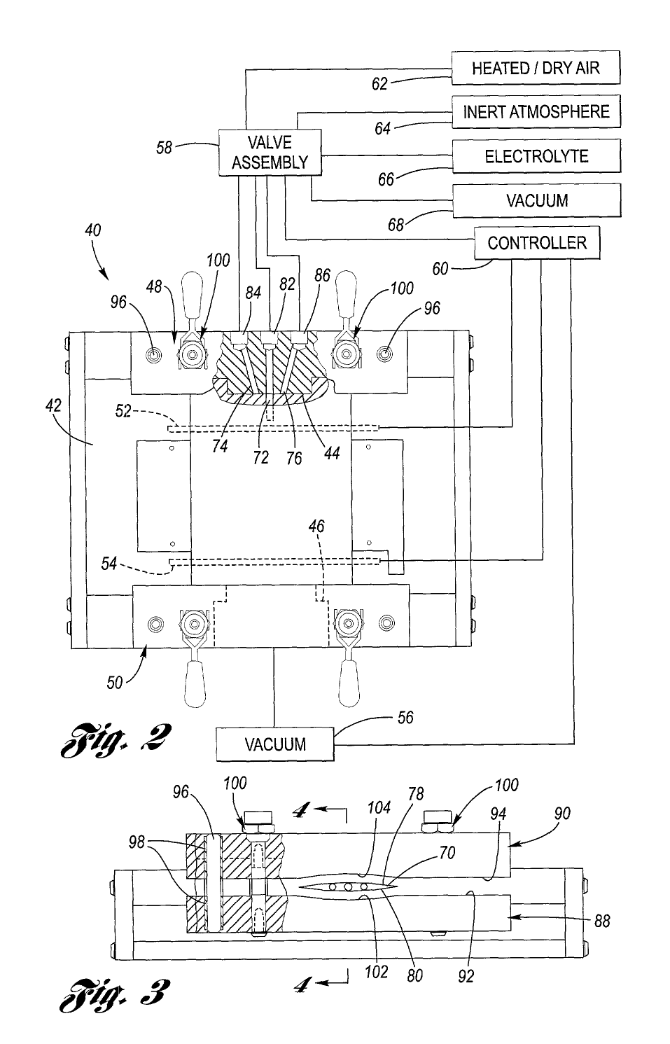

First nosepiece 44 is configured for insertion through a first, open side of the packaging 24 of battery 10, such as side 32 shown in FIG. 1. As will be described in greater detail hereinafter, first nosepiece 44 is configured to cooperate with first clamp and seal arrangement 48 to provide a tight, reliable seal around the packaging materials 24, as clamped against the nosepiece, to provide for fluid communication to interior 28. Nosepiece 44 includes a main body portion 70 (best shown in FIG. 3), and at least one conduit 72. Nosepiece 44 may, however, include further conduits, such as conduits 74 and 76 as shown in FIG. 2. The body portion 70 has an insertion end on a distal portion thereof, and may comprise conventional materials that are relatively inert with respect to conventional electrolytes used in lithium chemistry storage batteries. Body portion 70 also includes an upper convex surface 78, and a lower convex surface 80, as best shown in FIG. 3. First nosepiece 44 may further include one or more fittings (or openings therefor), such as fittings 82, 84 and 86 for each conduit of the nosepiece. Each conduit has a respective opening on the insertion end of the nosepiece for providing communication with interior 28 of battery 10.

Second nosepiece 46, shown in dashed line format in FIG. 2, is generally identical to nosepiece 44, will not be described separately. Second nosepiece is configured for insertion into an open side of packaging material 24 that is opposite the first open side in which nosepiece 44 is inserted.

First clamp and seal arrangement 48 is configured to seal battery 10 when the insertion end of nosepiece 44 is inserted in the open side of packaging 24. Likewise, second clamp and seal arrangement 50 is configured to seal storage battery 10 when its insertion end is inserted in the opposing, open side of packaging 24. It should be noted, that while the process for packaging shown in FIG. 1 results in a closed (and thus sealed) non-tab side 30, such side in the packaging may be opened for insertion of a nosepiece, such as nosepiece 46. Alternatively, packaging 24 may comprise, in the first instance, two separate sheets (in contrast to a single sheet), one each for covering the top and bottom of the bicells 12 wherein only the tab-sides 34, and 36 are sealed, leaving sides 30, and 32 open for nosepieces 44 and 46.

FIG. 3 is a side view of the first clamp and seal arrangement 48. It should be understood that second clamp and seal arrangement 50 may be identical to first clamp and seal arrangement 48, and will therefore not be described separately. First clamp and seal arrangement 48 includes a lower jaw member 88, an upper jaw member 90, opposing clamp surfaces 92 and 94, a plurality of pins 96 (best shown in plan view in FIG. 2) each disposed in a pair of bearings 98, and tensioning means 100, such as a screw, cam-actuated device, or the like. In an alternate embodiment, tensioning means may comprise an air or hydraulic cylinder to clamp the jaw members together.

Lower jaw member and upper jaw member 88 and 90 may comprise conventional materials known to those of ordinary skill in the art that possess sufficient strength to clamp and hold packaging 24 against the outer convex surfaces of the nosepiece. In one embodiment, the lower and upper jaw member may comprise aluminum material.

Pins 96 cooperate with it respective bearings 98 to allow up and down movement (i.e., along the longitudinal axis of the pins 96) of upper and lower jaw members one relative to the other. This feature allows the upper and lower jaw members 88 and 90 to be moved between (i) an insertion/release position for the initial insertion of the nosepieces into the packaging 24, and subsequent release after sealing, and (ii) a clamp position to effect the clamping and sealing functions of the packaging against the outside, convex surfaces of the nosepiece. Tensioning means 100 is configured to move the lower and upper jaw members 88 and 90 between the insertion (release) position and the clamp/seal position.

Opposing clamp surfaces 92 and 94 include concave features 102 and 104 which correspond in size and shape to the convex surfaces 80 and 78, respectively, of the nosepiece. When jaw members 88 and 90 are in the clamp/seal position, the clamp surfaces 92 and 94 are drawn closer to each, engaging and forcing the packaging against the nosepiece.

FIG. 4 is a simplified, cross-sectional view of one nosepiece taken substantially along lines 4-4 in FIG. 3. As shown in FIG. 4, in the clamp/seal position, the lower and upper jaw members 88 and 90 bear down on a lower, and an upper portion of packaging 24, effectively sandwiching packaging 24 against the outer, convex surfaces of the nosepiece. The clamp and seal arrangement 48 further includes a seal, such as an O-ring 106. The O-ring 106 is configured to insure that a sufficient seal is made, isolating the interior 28 of battery 10 from the uncontrolled atmosphere in which apparatus 40 is located, generally.

With continued reference to FIGS. 2, and 4, apparatus 40 may be manually operated, or may, in an alternate embodiment, be controlled in accordance with a preprogrammed strategy executed by controller 60. As to initial preparation, battery 10 is first moved to base 42. This may be done manually, or it can be done automatically as part of an overall in-line fabrication process. Such an in-line process is disclosed in an application entitled “BATTERY CONSTRUCTED WITH EXTRACTED BICELLS STACKED ON SHUTTLED PALLET”, attorney docket no. DP-306072, assigned to the common assignee of the present invention, and herein incorporated by reference. Next, nosepieces 44 and 46 are inserted in opposing, open sides of packaging 24, and the seal and clamp arrangements 48, and 50 are moved to respective clamp/seal positions.

Extraction

During an extraction phase, at least one of the conduits of first nosepiece 44 is configured for connection to an extraction fluid source, while the second nosepiece, via a corresponding conduit therein, is configured for connection to a vacuum source for drawing or pulling the extraction fluid through the interior 28 of battery 10, thereby extracting predetermined constituents (e.g., plasticizers) from bicells 12. In this regard, controller 60, according to its preprogrammed strategy, opens and closes valves contained in valve assembly 58 so as to connect the extraction fluid source, for example, heated, dry air from source 62, inert atmosphere from source 64, a combination of the foregoing, or any other source of extraction fluid (not shown). Controller 60 may close valves to other sources, such as electrolyte source 66, or vacuum source 68 that are unused during the extraction phase. Controller 60, further, is configured to activate vacuum source 56 during extraction, in order to establish a vacuum on the side of the battery into which second nosepiece 46 is inserted. As shown in FIG. 4, as a result of the foregoing, the arrows indicate a fluid flow emerging from nosepiece 44 over, under, and around bicells 12. Vacuum source 56 is configured to exhaust the heated, dry air/inert atmosphere pulled through storage battery 10 (the exhaust ducting is not shown).

Activation

During an activation phase, a conduit through first nosepiece 44 is configured for connection to an electrolyte source (e.g., source 66) for introducing electrolyte into the interior 28 to thereby activate the storage battery 10. It should be understood that in the automatically controlled embodiment, controller 60 configures valve assembly 58 to couple electrolyte source 66 to one or more of the conduits in first nosepiece 44, while closing connections to any one or more of the extraction fluid sources, and vacuum source 68. Controller 60, optionally, may further activate vacuum source 56 to facilitate drawing of the electrolyte through and into the interior 28, onto the bicells 12. Controller 60 may meter a predetermined amount of electrolyte into battery 10.

Sealing

During a sealing phase, controller 60 is configured to disconnect sources 62, 64, 66, and 68 from nosepiece 44 by suitable configuration of valve assembly 58, and further, deactivate vacuum source 56, all in anticipation of performing the final sealing of the open sides of the packaging. Thus, once the foregoing has been completed, controller automatically preheats sealing bars 52, and 54 (or it may have commenced preheat prior to or during the extraction and activation steps) and causes the sealing bars to engage the packaging 24 to make respective seals on the opposing, non-tab sides. The sealed areas are shown in exemplary fashion in dashed-line format in FIG. 2.

After the sealing operation, controller 60 causes the clamp and seal arrangements 48, and 50 to move away from the clamp/seal position to the insertion/release position, and the storage battery 10 is moved. This can be accomplished either manually through an operator, or automatically as part of an automated in-line manufacturing process (e.g., through use of conveyors, and the like), as described in copending application attorney docket no. DP306072 referred to above.

1. An apparatus configured to provide a fluid flow for a storage battery having an interior surrounded by packaging having at least a first open side, said apparatus comprising:
a nosepiece with an insertion end, said nosepiece having at least one conduit therethrough and having an opening on said insertion end for communicating with said interior; and
a clamp and seal arrangement configured to seal said storage battery when said insertion end of said nosepiece is inserted in said first side.

2. The apparatus of claim 1, wherein said nosepiece includes a plurality of conduits therethrough each having a respective opening on said insertion end.

3. The apparatus of claim 1, wherein said insertion end of said nosepiece has opposing, convex surfaces.

4. The apparatus of claim 3, wherein said clamp and seal arrangement includes an upper jaw member and a lower jaw member having opposing clamp surfaces.

5. The apparatus of claim 4, wherein said clamp and seal arrangement includes a seal disposed on said opposing clamp surfaces.

6. The apparatus of claim 1, wherein said seal comprises an O-ring seal.

7. The apparatus of claim 1, wherein said nosepiece is a first nosepiece, said insertion end is a first insertion end and said conduit is a first conduit, said apparatus further including a second nosepiece having a second insertion end configured for insertion in a second open side of said cell opposite said first side, said second nosepiece having a second conduit and having a second opening on said second side for communicating with said interior, and therein said clamp and seal arrangement is a first arrangement, said apparatus further comprising a second clamp and seal arrangement associated with said second nosepiece for communicating with said interior.

8. The apparatus of claim 7, wherein one of said first and second conduits is coupled to a fluid source selected from the group comprising dry air, heated dry air, inert atmosphere and electrolyte, and the other one said first and second conduits is coupled to a vacuum for pulling said fluid across said interior of said battery.

9. The apparatus of claim 8, further comprising a first sealing device configured to seal said first open side and a second sealing device configured to seal said second open side.

10. The apparatus of claim 9, further including a control unit for configuring said conduits, during a first phase, so that said vacuum pulls heated dry air across said battery to thereby effect extraction, said control unit being further arranged to configure said conduits, during a second phase after said first phase, to introduce a predetermined amount of electrolyte into said interior of said, said control unit being further arranged, during a third phase after said second phase, to cause said first and second sealing devices to seal said first and second open sides.

11. An apparatus comprising:
a base for receiving a storage battery having an interior with at least one bicell surrounded by packaging, said packaging being sealed on a first pair of opposing sides and open on a second pair of opposing sides;
a first nosepiece with a first insertion end, said first nosepiece having at least a first conduit having a first opening on said first insertion end for communicating with said interior;
a second nosepiece with a second insertion end, said second nosepiece having at least a second conduit having a second opening on said second insertion end for communicating with said interior; and
a first and a second clamp and seal arrangements configured to seal said storage battery when said first and second insertion ends are inserted in said second, open pair of opposing sides.

12. The apparatus of claim 11, wherein said first conduit being configured for connection to an extraction fluid source, said second conduit being configured for connection to a vacuum source for drawing said extraction fluid through said interior thereby extracting predetermined constituents from said bicell.

13. The apparatus of claim 12, wherein said first conduit is further configured for connection to an electrolyte source for introducing electrolyte into said interior to thereby activate said storage battery.

14. The apparatus of claim 13, wherein said first nosepiece further includes a third conduit having a respective opening on said first insertion end for communication with said interior, said third conduit being configured for connection to an electrolyte source for introducing electrolyte into said interior to thereby activate said storage battery.

15. The apparatus of claim 14, further comprising a pair of sealing devices for sealing said pair of open ends.

16. A method of making a storage battery having an interior containing at least one bicell and which is surrounded by packaging, the packaging having a sealed pair of opposing sides and an open pair of opposing sides, said method comprising the steps of:
(A) inserting a first nosepiece in one of said pair of open sides and a second nosepiece in the other one of said pair of open sides;
(B) clamping said open pair of sides over said first and second nosepieces using opposing jaw members having a seal; and
(C) introducing an extraction fluid through said first nosepiece and exhausting through said second nosepiece via a vacuum pull to thereby extract predetermined constituents from said bicell.

17. The method of claim 16, further including the step of:
introducing an electrolyte into the interior by way of one of the first and second nosepieces.

18. The method of claim 16, further including the step of:
sealing the pair of opposing open sides of the packaging using a pair of sealing devices.
